(19) United States
(12) Patent Application Publication
(10) Pub. No.: US 2021/0231477 A1
(43) Pub. Date: Jul. 29, 2021

(54) Pressure-difference-based flow-measurement device for gases

(71) Applicants: SALVUS TECNOLOGIA LTDA - EPP, RECIFE (BR); CESAR CENTRO DE ESTUDOS E SISTEMAS AVANQADOS DO RECIFE, Recife (BR)

(72) Inventors: Maristone GOMES DA SILVA JUNIOR, RIO (BR); Caio CESAR BARBOSA DA SILVA, Rio (BR); Daniel THIAGO VASCONCELOS PEREIRA, Rio (BR); Rafael DE LIMA PACHECO SILVA, Rio (BR); Cristóvão ZUPPARDO RUFINO, Rio (BR); Felix GALVÃO BATISTA NETO, Rio (BR)

(21) Appl. No.: 17/273,301

(22) PCT Filed: Sep. 3, 2019
(86) PCT No.: PCT/BR2019/050366

§ 371 Date: Mar. 3, 2021

(30) Foreign Application Priority Data
Sep. 3, 2018 (BR) BR1020180676601

(51) Int. Cl. G01F 1/42; G01L 19/14

(52) U.S. Cl. CPC G01F 1/42; G01L 19/142

(57) ABSTRACT

The “PRESSURE-DIFFERENCE-BASED FLOW-MEASUREMENT DEVICE FOR GASES” relates to a device that generates a pressure difference originating from a mechanical restriction of the flow of gases and which provides easy connection to digital measurement equipment, providing high-precision values. Said device comprises a body (1) made from plastics, provided with a pipe (2) for gases with connections at each of the ends, two pressure take-offs (5) on the front face for connection to a pressure differential sensor, and a flow-restriction plate (6) that divides the tube (2) into two compartments in order to create the pressure difference. Connected to this invention is a device comprising a pressure-difference sensor (7) capable of being connected to the Internet and processing the data received using artificial intelligence and machine learning and of presenting the data to the user on an online platform.

### FIELD OF THE INVENTION

The present invention relates to a device capable of generating a pressure differential from a mechanical restriction in the flow of gases, adapted to connect in the present configurations of gas deliveries, providing greater precision in flow measurement and ease of integration with electronic devices.

### PREVIOUS

The use of a tube with flow restriction per orifice plate to measure the speed and flow of a gas is a technique commonly used and applied in areas where this measure is necessary for the control and management of gases. As they restrict the flow considerably, it is recommended to use it in high-load liquid gases or in low-speed gases. Thus, this device is especially applied in the industry and it is estimated that in the United States, about 50% of this sector uses this device, since they provide simplicity, low production cost, absence of moving parts, low maintenance and applicability to different types of gases. Given the possibility of application in low speed gases, these devices are also found in the hospital area. It is possible to mention, for example, its use to control the flow of gases supplied by cylinders, in which they are commonly used to reduce the flow and delivery pressure of the same. They are also commonly found in pulmonary ventilators to measure the patient's inspired and expired air flow. In this way, they make it possible to measure direct information, such as the flow rate of gases, and indirect ones, such as respiratory rate, lung capacity.

Considering the measurement of the gas flow that are provided by cylinders, rulers and other modes of delivery of air gases, we have that it currently takes place by exclusively analog devices (such as flowmeter type flowmeters), or digital. It is necessary, however, an intermediate technology that is capable of providing both forms of measurement and that does not disturb the routine of using devices that are strongly implemented in the hospital routine, as is the case with flowmeters of the type rotameters.

Flow meters by orifice plates consist of devices that have a tube cross-sectioned by a plate, drilled by a generally concentric orifice, the medium through which the gases must follow to remain in the flow direction.

The flow of gases through the orifice generates an increase in pressure on the anterior side of the plate and a pressure drop on the posterior side, resulting in an increase in the speed of the gases through the orifice. This pressure difference, then, can be measured from pressure taps on the side of the tube and, after mathematical calculations, can correspond to the flow of the mass of gases that flows internally to the device.

Considering the hospital, industrial or chemical process environment, the devices that make the acquisition and availability of these signals for capture by electronic equipment can operate through several principles such as ultrasonic, doppler effect, magnetic induction, optical interference, among others. Thus, in addition to using complex implementation technologies, they are usually purely digital, eliminating or impairing the use of analog devices, still common in environments such as industrial and hospital.

In turn, it is also common to use only and exclusive purely analog devices, as is the case of reading flow through the rotameters. These devices, created around 1908, by Karl Kueppers, consist of a tube whose shape resembles that of a cone trunk. Its widest end is closed and its narrowest end connects to the outlet of the gases of Interest. Inside, there is a generally spherical object, whose radius is slightly smaller than the smallest radius of the tube. When connecting the gas outlet, the direction of flow in the tube will be from bottom to top, suspending the sphere according to its Intensity. These tubes are usually transparent and have a graduated ruler on the outside with numerical markings in the measurement system of interest to the user. These configurations make it possible to read the flow equivalent to the height with which the sphere is suspended.

Due to large tolerances in the manufacturing process and errors inherent to the measurement method used, consisting of the observation of the graduated ruler, as well as the low natural accuracy of rotameters, these devices are sources of measurement error, since the flow reading is performed from the visual observation of the graduated rule by the patient, guardians or health professionals, and is subject to two types of errors, systematic and random.

The systematic and random errors observed in the practice of reading the rotameter can be divided into 4 categories, which are the “instrumental”, “observational”, “environmental” and “theoretical” errors. In the case of “instruments”, it was possible to observe that the poor calibration of the devices or the low precision associated with them can create random variations in the reading of up to 20% of the actual observed value, depending on the flow regime and variation of the models available in the market. The “observationals” are characterized by parallax, that is, an apparent displacement caused by the non-alignment of the observer with the ideal reading position of the device; a problem that is amplified in the case of rotameters found on the market due to the use of a sphere to determine the measured flow and its center represents the exact measurement. The “environmental” errors are caused by variations in temperature and pressure where the device is located and although calibrated to 25 degrees Celsius, most operating environments are at temperatures below. Finally, “theoretical” errors occur not in the reading of the device, but in the way the data is cataloged and interpreted by those responsible for the treatment and occurs when the pressure variations caused by the errors mentioned above are not taken into account thanks over-simplification of calculations and methods.

Thus, in order to provide a more complete reading of the flow value, the object of the present invention has as main objective to perform this integration with the electronic environment, so that the hospital routine is not altered, but that this data can be used and manipulated in a more complete and profound way.

U.S. Pat. No. 3,718,135, dated Mar. 1, 1971, demonstrates a pneumotachograph to measure the flow of respiratory gases for small animals and which consists of a resistive element in the center of a tube, which causes a proportional pressure drop to the gas flow, being linear between 0 and 2 l/min. However, observing the aforementioned invention, we note the absence of components necessary for integration with gas delivery systems, as well as the absence of pressure taps for coupling with pressure differential sensors.

Another U.S. Pat. No. 5,720,709, dated Aug. 1, 1996, reports the construction of an apparatus for measuring airway resistance through brief occlusion during inhalation. In this invention, a pneumotachograph is used next to the patient's mask to measure the flow of inspired and expired air. Although the apparatus is used to measure the volume breathed, the invention is not applied to measure how much input was consumed.

The US patent US 005099.698A, of Mar. 31, 1992, reports the construction of an electronic device for measuring the height of the sphere inside the rotameter using an optical scanner, a mirror system and a photodetector. In this invention, the rotameter is Illuminated by a light source, if necessary, and the generated image is directed by a mirror to the photodetector or to a Charged Coupled Device (CCD). The flow value is obtained through the time that the image of the sphere took to appear on the photodetector/CCD. The light sensors, in turn, are capable of converting the light stimulus into an electrical signal, so that this mechanism can be acquired by digital displays or by a personal computer for automatic data collection. This patent, however, has data collection devices that can impair the visual inspection of the gradation of the tube. In addition, optical systems are sensitive to variations in light intensity, which can occur at any time, such as power outages or changes in ambient lighting, for example.

So, observing the skills of an orifice plate for creating a pressure difference and the need to implement a device that is capable of providing flow information to electronic equipment, without the routine of using devices analog devices is modified, the invention described in this report appears. This device consists of a single module to fit gas delivery devices and a tube with a restrictor plate inside, to reduce the pressure in the gas flow. This orifice pate is positioned between two pressure taps, which can be connected to electronic devices that have sensors suitable for measuring the flow from the differential pressure.

It can be said, then, that the present invention constitutes a device capable of improving analog flowmeters and rotameters, which can be added to the system without changing the way professionals interact with the current configuration, but providing an interface to connect flow sensors to electronic devices, complementing this measurement. In this way, the data collected by the The device can be used for the purposes of checking, calibrating, monitoring the treatment, calculating the residual volume of a cylinder or simply as a more reliable way of reading, to the detriment of the visual reading of the rotameter.

In conjunction with an electronic device equipped with a pressure difference sensor, the present device also features a solution to the errors mentioned above, providing continuous readings, with an accuracy in the order of 2.5%, where no measurement is required, visual reading of the device by the health professional, completely eliminating the “observational” errors generated by the parallax or by not understanding the scale.

The “Device for measuring flow by pressure difference for gases” is constructed in order to adapt most of the available configurations for gas delivery, using 9/16″×18 UNF Female thread, common in flow meters and threads 9/16″×18 UNF Male for connection with other delivery systems suitable for the desired gas therapy.

It consists of two pressure taps divided by a plate that segments the tube where the system is located, creating a restriction in the continuity of the gases, which results in a change in the flow regime and, consequently, generates a pressure difference. These pressure taps were optimized to use common tubings in the hospital environment, both to prevent the leakage of gases between the device and the sensor, and to facilitate maintenance.

### GENERAL DESCRIPTION

The “Device for measuring flow by pressure difference for gases” can be better understood through the figures, as detailed below:

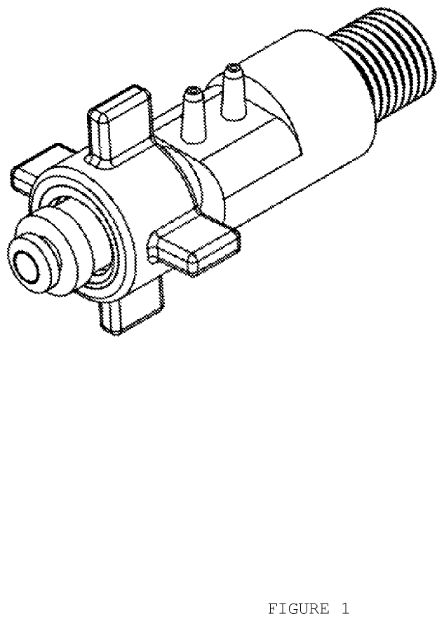

FIG. 1—presents a perspective view;

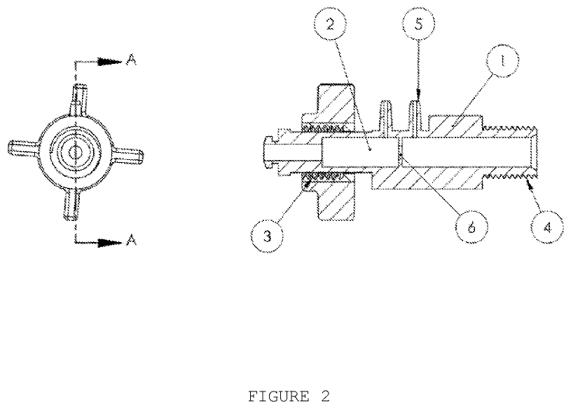

FIG. 2—shows a cross-sectional view;

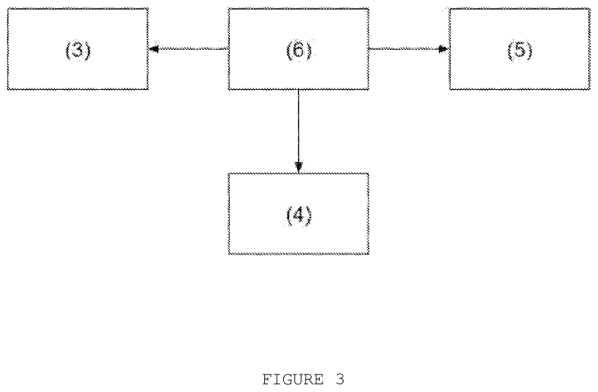

FIG. 3—presents a block diagram of the process and equipment connected to it;

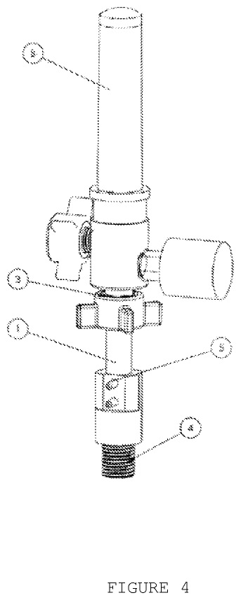

FIG. 4—it has a typical assembled device;

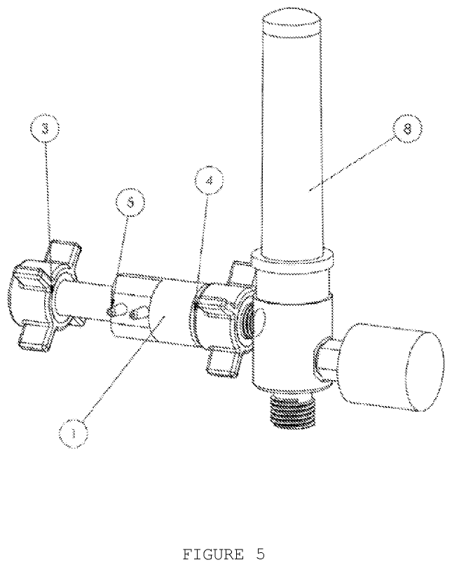

FIG. 5—features a device mounted in an alternative mode.

Referring to the figures, it can be seen that the body (1) of the device is comprised of a tube (2) in its center, segmented by a restricting plate (6) in the body (1) of the device. Each side of the tube (2) is terminated by a 9/16″×18 UNF Female thread (3) and another 9/16″×18 UNF Male thread (4) respectively, from left to right as shown in FIG. 2.

The restrictor plate (6) subdivides the tube (2) in two compartments connected by a small segment, which in turn aims to create a pressure difference by changing the flow regime of the gases that will pass internally to the device. This pressure difference can be measured from the device using the two pressure taps (5) contained on the front face and which are adapted for use with rubber tubings.

The “Device for measuring flow by pressure difference for gases” must then be connected to pressure differential sensors present in the measuring equipment so that it makes the appropriate acquisition and interpretation of the data collected in the system.

The 9/16″×18 UNF Female (3) and 9/16″×18 UNF Male (4) wheels illustrated in FIG. 2, combine the function of connecting the device to the gas delivery solutions currently available on the market, which may or may not be used with the presence of an analog flowmeter (8) to provide flow visualization locally.

Installation takes place by coupling the 9/16″×18 UNF Female thread (3) in the rotameter analog flowmeter (8), followed by the connection of the gas release systems to the 9/16″×18 UNF Male thread (4), and connection of the sensor, through tubings, to the pressure taps (5).

The operation of the “Device for measuring flow by pressure difference for gases” consists of gases passing through the tube (2) passing through the restrictor plate (5) and changing the flow regime. This regime change causes a difference in the pressure collected by each pressure tap (5) and, after mathematical calculations performed on a measuring equipment, it is possible to obtain the gas mass flow rate with an accuracy of 2.5%.

### Modalities

The preferred modality consists of a device made of plastic with two pressure taps on its front face and two connections for medical gas pipes, more specifically medical oxygen. The first connection corresponds to a 9/16″×18 UNF Female thread, which must be connected to a rotameter. The second connection corresponds to a 9/16″×18 UNF Male thread, which must connect to the appropriate release systems to desired gas therapy. The two pressure taps are used to connect rubber tubings, which in turn connect with the differential pressure sensors present in another device. The plastic structure has a body that includes the aforementioned connections and a flow restrictor plate that internally segments the body into two parts.

Another modality of the present device consists only in changing the positioning of the device in question, which in this situation will be found between the pressure valve or gas delivery pipe and the rotameter. The other configurations are maintained, consisting of a device made of plastic with two pressure taps on its front face and two connections for medical gas pipes, more specifically medical oxygen. The first connection corresponds to a 9/16″×18 UNF Female, thread, which must connect to the pressure valve outlet directly connected to the oxygen cylinder or the gas delivery pipe. The second connection corresponds to a 9/16″×18 UNF Male thread that should be connected to the rotameter butterfly kit, which, in turn, connects normally through its regular outlet to the appropriate delivery systems for the desired gas therapy. The two pressure taps are used to connect rubber tubings, which in turn connect with the pressure differential sensors present in another device. The plastic structure has a body that includes the aforementioned connections and a flow restrictor plate that segments the body into two parts.

1. “FLOW MEASUREMENT DEVICE FOR PRESSURE DIFFERENCE FOR GASES”, comprising a single body (1), equipped with a gas pipe (2) connected to an orifice restrictor plate for partial obstruction of the flow in a pipe, which segments the piping (2) in two compartments, providing a pressure difference, in which each compartment is provided with a pressure outlet (5), totaling two sockets, characterized by this restrictor plate having a hole whose diameter may vary from 1 mm to 3 mm in diameter (6), the last compartment being comprised of a connection A (3), in an auxiliary body, and opposite to that connection, a connection B (4), for connection with other devices.

2. “DEVICE FOR MEASURING FLOW BY PRESSURE DIFFERENCE FOR GASES”, according to claim 1, characterized by the connection A (3) being a threaded connection of the type 9/16″×18 UNF Female.

3. “DEVICE FOR MEASURING FLOW BY PRESSURE DIFFERENCE FOR GASES”, according to claim 1, characterized by the connection A (3) being a quick connection for nipple fitting.

4. “FLOW MEASUREMENT DEVICE FOR PRESSURE DIFFERENCE FOR GASES”, according to claim 1, characterized by connection A (3) being a nipple connection.

5. “DEVICE FOR MEASURING FLOW BY PRESSURE DIFFERENCE FOR GASES”, according to claim 1, characterized in that connection B (4) is a threaded connection of the type 9/16″×18 UNF Male.

6. “FLOW MEASUREMENT DEVICE FOR PRESSURE DIFFERENCE FOR GASES”, according to claim 1, characterized by connection B (4) being a nipple connection.

7. “DEVICE FOR MEASURING FLOW BY PRESSURE DIFFERENCE FOR GASES”, according to claim 1, characterized by connection A (3) that can be connected to a pressure gauge, rotameter (8), or other gas release devices.

8. “DEVICE FOR FLOW MEASUREMENT BY PRESSURE DIFFERENCE FOR GASES”, according to claim 1, characterized by connection B (4) that can be connected to the rotameter or other gas release systems.

9. “DEVICE FOR MEASURING FLOW BY PRESSURE DIFFERENCE FOR GASES”, according to claim 1, characterized by two pressure taps (5) of conical tubular shape, for connecting tubings connected to a differential pressure sensor.

10. “DEVICE FOR MEASURING FLOW BY PRESSURE DIFFERENCE FOR GASES”, according to claim 1, characterized by two pressure taps (5) for direct connection of an electronic flow sensor by pressure differential.
